(19) United States
(12) Patent Application Publication
(10) Pub. No.: US 2015/0233455 A1
(43) Pub. Date: Aug. 20, 2015

(54) ROLLER SCREW, MOUNTING METHOD AND TOOL FOR FITTING ROLLERS IN SUCH A ROLLER SCREW

(71) Applicants: Christophe MAGNIN, Albens (FR); David RICHARDET, Viviers-du-Lac (FR)

(72) Inventors: Christophe MAGNIN, Albens (FR); David RICHARDET, Viviers-du-Lac (FR)

(73) Assignee: AKTIEBOLAGET SKF, Goteborg (SE)

(21) Appl. No.: 14/620,922

(22) Filed: Feb. 12, 2015

(30) Foreign Application Priority Data
Feb. 14, 2014 (FR) 1451199

(51) Int. Cl. F16H 25/22; F16H 57/023; F16H 57/02

(52) U.S. Cl. CPC F16H 25/2252; F16H 57/02004; F16H 57/023

(57) ABSTRACT

A roller screw mechanism comprising a screw having an outer threading, a nut arranged around and coaxially to the screw, the nut having an inner threading, and a plurality of mutually identical rollers interposed between the screw and the nut. Each mutually identical roller having an outer threading engaged with the outer and inner threadings of the screw and of the nut. The threading of each roller being prolonged axially at each end by teeth respectively engaged with teeth of two annular gear wheels fixed in an unthreaded part of the bore of the nut. Each of the mutually identical rollers comprises an angular visual positioning feature, making it possible to place the rollers in one of the annular gear wheels with respect to a predetermined reference point of the gear wheel.

### CROSS REFERENCE TO RELATED APPLICATION

This is a National Stage application claiming the benefit of France Patent Application Number 1451199 filed on 14 Feb. 2014 (14.02.2014), which is incorporated herein by reference in its entirety.

### FIELD OF THE INVENTION

The present invention relates to the field of roller screw mechanisms that make it possible to convert a rotational movement into a linear translational movement, and vice versa. Such a mechanism is provided with a screw having an outer threading, a nut arranged around the screw and having an inner threading and a plurality of longitudinal rollers engaged respectively with the outer and inner threadings of the screw and of the nut.

### SUMMARY OF THE INVENTION

A first type of roller screw mechanism comprises rollers having an outer threading engaged with the outer and inner threadings of the screw and of the nut. The threadings of the rollers and the threading of the nut exhibit mutually identical helix angles different from that of the threading of the screw, such that, when the screw turns relative to the nut, the rollers turn on themselves and roll around the screw without being displaced axially within the nut. The rollers are guided in rotation parallel to the axis of the screw by teeth mounted on the nut and engaged with teeth of the rollers. Such a mechanism is called satellite roller screw.

A second type of roller screw mechanism has a similar operating principle but is differentiated by a reversed position. The helix angles of the threadings of the rollers, of the screw and of the nut are chosen such that, when the screw turns relative to the nut, the rollers turn on themselves around the screw and are displaced axially in the nut. The rollers are guided in rotation parallel to the axis of the screw by teeth formed thereon and cooperating with teeth of the rollers. Such a mechanism is called inverted satellite roller screw.

To fit the rollers in the roller screw mechanism, the rollers are fitted one by one manually and with extreme care until the start of the threads is arranged at the right point.

However, the rollers must be positioned in the nut in such a way as to have the same axial position. In effect, when the roller is fitted in the nut in the known manner, the teeth of the roller mesh with the gear wheel and the journals are positioned in a void of the annular spacer rings. If the axial position of the roller is not right, that is to say that the roller is not in the axis of the nut, then there is a radial play between the teeth of the roller and the gear wheels.

The aim of the present invention is therefore to resolve these drawbacks by proposing a roller screw mechanism of simple design and that is easy to fit, while minimizing the radial play between the teeth of the roller and the gear wheels.

In one embodiment, a roller screw mechanism comprises a screw having an outer threading, a nut arranged around and coaxially to the screw, the nut having an inner threading, and a plurality of mutually identical rollers interposed between the screw and the nut and each having an outer threading engaged with the outer and inner threadings of the screw and of the nut. The threading of each roller is prolonged axially at each end by teeth which are themselves prolonged axially by a cylindrical journal extending outwards. The roller screw mechanism further comprises two annular gear wheels fixed in an unthreaded part of the bore of the nut and each internally comprising teeth respectively engaged with the teeth of the rollers and two annular spacer rings each fitted radially between the screw and the associated gear wheel and comprising a plurality of cylindrical through voids distributed evenly in the circumferential direction and inside which the journals of the rollers are housed.

Each of the rollers comprises an angular visual positioning feature making it possible to place the rollers in the gear wheel with respect to a predetermined reference point of the gear wheel or on the nut. The angular visual positioning feature of the rollers must be situated at the same point for each of the rollers, for example at the start of the thread.

Advantageously, the angular visual positioning feature is produced outside the threading.

According to one embodiment, the angular visual positioning feature is produced on the lateral radial surface or the cylindrical axial surface of one of the sets of teeth.

According to one embodiment, the angular visual positioning feature is produced on the lateral radial surface or the cylindrical axial surface of one of the journals.

According to one embodiment, the angular visual positioning feature is a deformation, a machining or a marking.

According to one embodiment, the angular visual positioning feature is produced before the threading of the roller.

According to a second aspect, the invention relates to a fitting tool capable of fitting rollers in a roller screw mechanism described previously. The fitting tool comprises an annular body having a cylindrical through piercing having an inner diameter greater than the outer diameter of the nut and a plurality of cylindrical through voids distributed evenly in the circumferential direction and each having an angular visual positioning feature for each of the rollers.

According to a third aspect, the invention relates to a method for fitting rollers in a roller screw mechanism described previously, in which a reference point is determined on the gear wheel or on the nut; a first roller is positioned in the associated void of the annular spacer ring so that the angular visual positioning feature of the first roller is facing the predetermined reference point; and the first roller is made to turn on itself until the adjacent void formed in the annular spacer ring is level with the predetermined reference point.

In order to fit the second roller in the gear wheel, a second roller is positioned in the associated void of the annular spacer ring so that the angular visual positioning feature of the second roller is facing the predetermined reference point; and the second roller is made to turn on itself until the adjacent void formed in the annular spacer ring is level with the predetermined reference point and the step of placement and rotation is repeated for each of the rollers.

After having positioned the first roller in the gear wheel, the fitting tool can be positioned around the nut in such a way that the angular visual positioning feature of the fitting tool is in the same angular position as the angular visual positioning feature of the first roller and all the other rollers are then positioned in the angular positions corresponding to the angular positions of the angular visual positioning feature of the fitting tool.

### BRIEF DESCRIPTION OF THE DRAWINGS

The present invention will be better understood on studying the detailed description of embodiments taken as non-limiting examples and illustrated by the attached drawings in which:

FIG. 1 is a partial view in axial cross section of a roller screw mechanism according to one embodiment of the invention;

FIG. 2 is a perspective view of a roller according to a first embodiment of the invention;

FIG. 3 is a perspective view of a roller according to a second embodiment of the invention;

FIGS. 4, 5 and 6 illustrate the steps of the method for fitting rollers in the roller screw mechanism of FIG. 1; and

FIG. 7 is a front view of a tool for fitting rollers in the roller screw mechanism of FIG. 1.

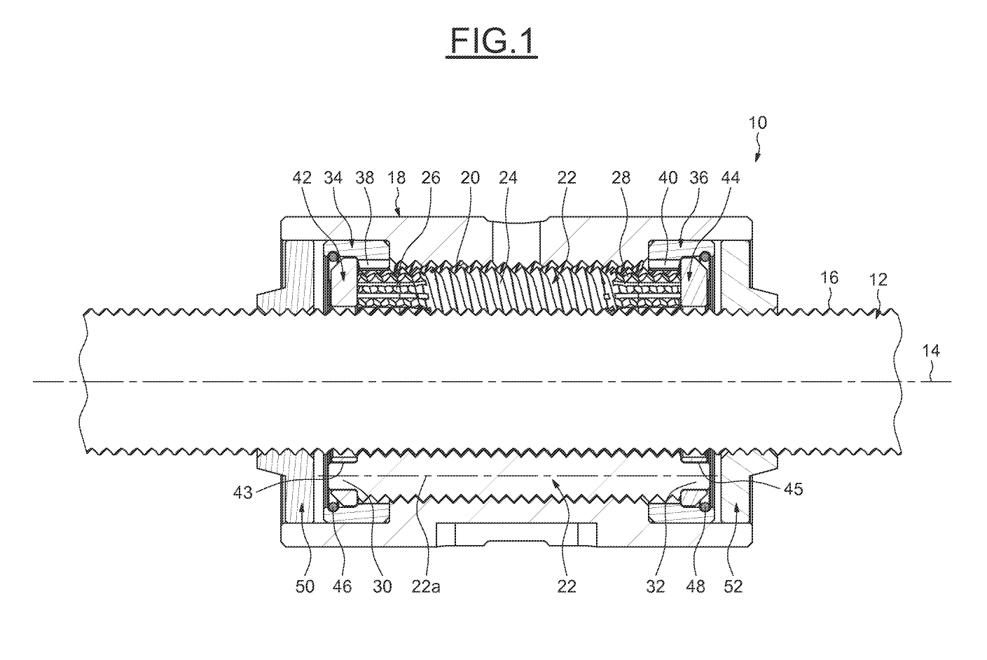

### DETAILED DESCRIPTION OF EXEMPLARY EMBODIMENTS OF THE INVENTION

As illustrated in the figures, a roller screw mechanism, referenced 10 as a whole, comprises a screw 12, of axis 14, provided with an outer threading 16, a nut 18 fitted coaxially around the screw 12 and provided with an inner threading 20, and a plurality of longitudinal rollers 22 arranged radially between the screw 12 and the nut 18. The inner threading 20 of the nut 18 has an inner diameter which is greater than the outer diameter of the outer threading 16 of the screw 12. The screw 12 extends longitudinally through a cylindrical bore (not referenced) of the nut 18 on which the inner threading 20 is formed.

The rollers 22, n in number, are mutually identical and distributed evenly around the screw 12. Each roller 22 extends along an axis 22a coaxial to the axis 14 of the screw 12 and comprises an outer threading 24 engaged with the threading 16 of the screw 12 and the threading 20 of the nut 18. The threading 24 of each roller is prolonged axially at each end by teeth 26, 28 which are themselves prolonged axially by a cylindrical journal 30, 32 extending outwards.

The roller screw mechanism 10 comprises two annular gear wheels 34, 36 fixed in an unthreaded part of the bore of the nut 18 and each comprising, internally, teeth 38, 40 respectively engaged with the teeth 26, 28 of the rollers 22 for their synchronization.

The roller screw mechanism 10 also comprises two annular spacer rings 42, 44 each fitted radially between the threading 16 of the screw 12 and the associated gear wheel 34, 36. Each annular spacer ring 42, 44 comprises a plurality of cylindrical through voids 42a, 44a distributed evenly in the circumferential direction and inside which the journals 30, 32 of the rollers 22 are housed. The annular spacer rings 42, 44 make it possible to bear the rollers 22 and maintain a regular circumferential spacing of the rollers.

As illustrated, the roller screw mechanism 10 also comprises retaining rings 46, 48 fitted in a groove (not referenced) provided in the bore of the associated gear wheel 34, 36 and designed to secure the corresponding spacer ring 42, 44 axially, and two end caps 50, 52 fixed in the bore of the nut in the vicinity of the rings 42, 44. The caps 50, 52 axially block the bore of the nut 18 and each have a threading (not referenced) cooperating with the threading 16 of the screw 12.

The threadings 24 of the rollers 22 and the threading 20 of the nut 18 have mutually identical helix angles different from that of the threading 16 of the screw 12, such that, when the screw 12 turns relative to the nut 18, the rollers 22 turn on themselves and roll around the screw 12 without being displaced axially within the nut 18. The rollers 22 are guided in rotation parallel to the axis 4 by the teeth 38, 40 of the gear wheels 34, 36. The screw 12 can move axially or longitudinally relative to the rollers 22.

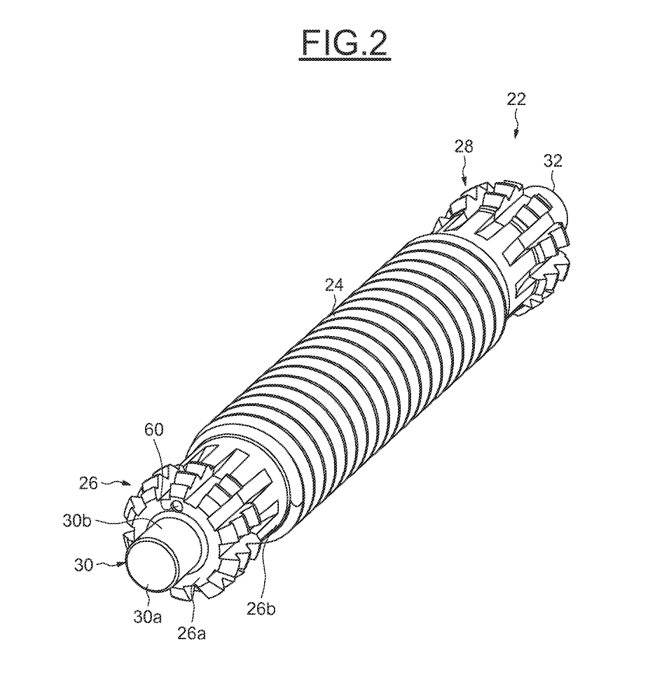

As illustrated in FIG. 2, each of the rollers 22 comprises an angular visual positioning feature 60 making it possible to place the rollers 22 in the gear wheels 34, 36 relative to a predetermined reference point of one of the gear wheels 34. The angular visual positioning feature 60 is produced outside the threading 24, on the lateral radial surface 26a of one of the sets of teeth 26 of the roller 22. The angular visual positioning feature 60 can be produced before the threading of the roller 22.

As illustrated in FIG. 2, the angular visual positioning feature 60 is produced by machining a rounded form. As a variant, provision could be made for the angular visual positioning feature 60 to be a deformation or a marking, such as, for example, paint. It will be noted that any other form could be provided for the angular visual positioning feature 60.

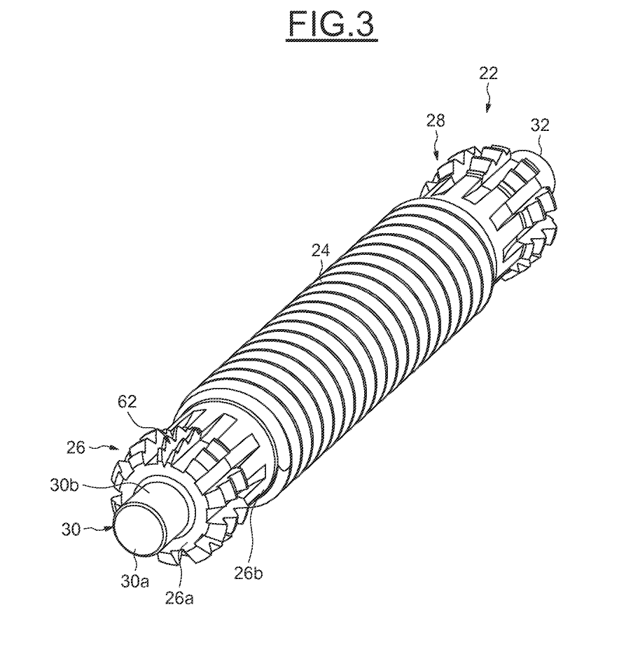

The embodiment illustrated in FIG. 3, in which the identical elements bear the same references, differs from the embodiment illustrated in FIG. 2 only by the position of the angular visual positioning feature. As illustrated in FIG. 3, each of the rollers 22 comprises an angular visual positioning feature 62 produced outside the threading 24, on the axial cylindrical surface 26b of one of the sets of teeth 26 of the roller 22 and is prolonged on the radial lateral surface 26a of the teeth 26. It is in fact possible to have a triangular form appear on the radial lateral surface 26a of the teeth 26.

As illustrated in FIG. 3, the angular visual positioning feature 62 is a machining produced before the threading of the roller 22. As a variant, provision could be made for the angular visual positioning feature 62 to be a deformation or a marking.

As a variant, provision could be made for the angular visual positioning feature 60, 62 to be produced on the lateral radial surface 30a or the cylindrical axial surface 30b of one of the journals 30.

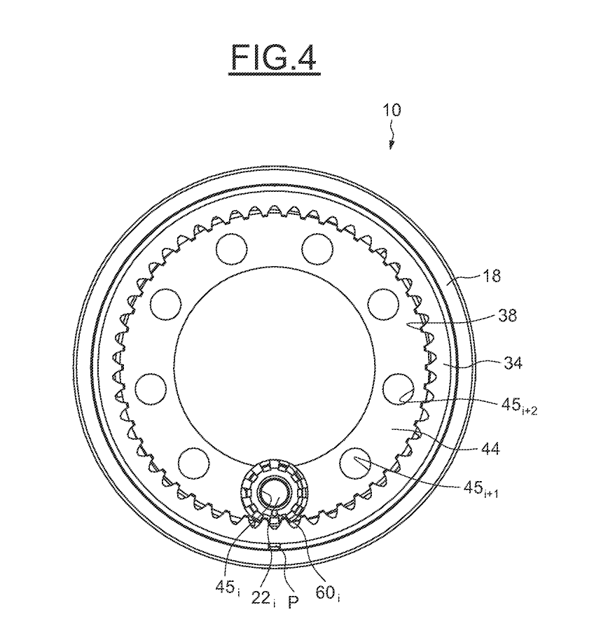

The rollers 22 are fitted in the nut 18 as follows with reference to FIGS. 4 to 6:

As illustrated in FIG. 4, a reference point P is determined on the gear wheel 34. As a variant, the reference point could be determined on the nut 18. Once the reference point P has been determined, a first roller 22i is positioned manually in the associated void 45i of the annular spacer ring referenced 44 so that the angular visual positioning feature 60i of the first roller 22i is facing the predetermined reference point P, i being the number of rollers 22 and of voids 45, between 1 and n. As illustrated in the figures, the number n is equal to eight. As a variant, a number n greater than or less than eight could be provided.

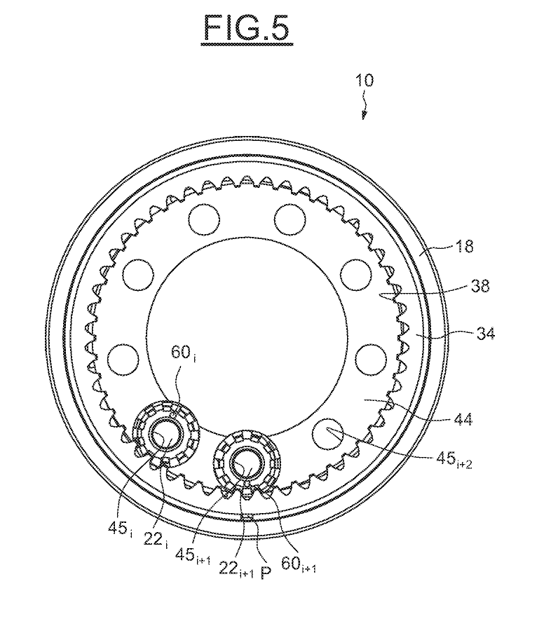

The first roller 22i is then manually made to turn on itself so that it is displaced radially in the gear wheel 34 until the adjacent void 45i+1 formed in the annular spacer ring 44 is level with the previously predetermined reference point P, as can be seen in FIG. 5.

As illustrated in FIG. 5, a second roller 22i+1 is positioned in the associated void 45i+1 of the annular spacer ring 44 so that the angular visual positioning feature 60i+1 of the second roller 22i+1 is facing the predetermined reference point P.

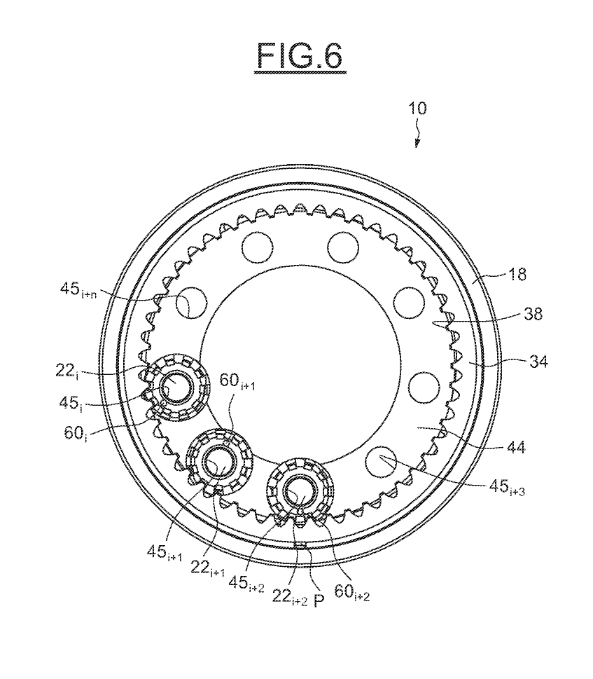

As illustrated in FIG. 6, the second roller 22i+1 is made to turn on itself in such a way that it is displaced radially in the gear wheel 34 until the adjacent void 45i+2 formed in the annular spacer ring 44 is level with the predetermined reference point P and a third roller 22i+2 is positioned in the associated void 45i+2 of the annular spacer ring 44 so that the angular visual positioning feature 60i+2 of the third roller 22i+2 is facing the predetermined reference point P.

The steps of placement and rotation of the rollers 22 are repeated for each roller.

Thus it is possible to fit the rollers in the gear wheel 34, 36 as a function of the reference point determined in the gear wheel 34 in a plurality of fitting operations.

As illustrated in the figures, the rollers are positioned in such a way that the angular visual positioning feature 60 are each time aligned with the reference point P on the gear wheel 34 and radially directed outwards. As a variant, the position of the angular visual positioning feature 60 relative to the reference point P on the gear wheel 34 could be defined in any other way. For example, the angular visual positioning feature 60 can be, each time, aligned with the reference point P on the gear wheel 34, but radially directed inwards, or form an angle with the reference point P.

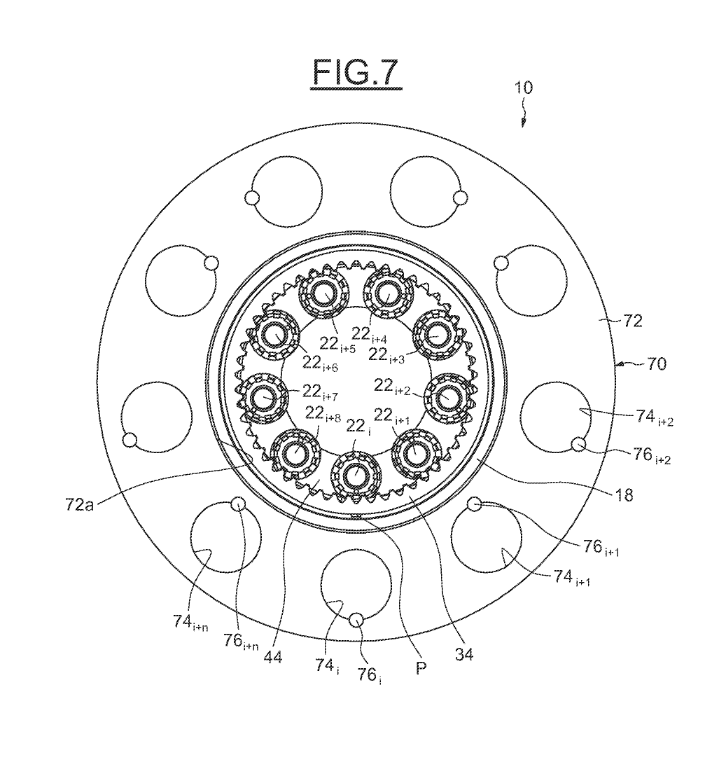

The embodiment illustrated in FIG. 7, in which the identical elements bear the same references, differs from the embodiment illustrated in FIGS. 4 to 6 by the fact that a fitting tool 70 is used in order to fit the rollers 22 in the gear wheel 34 of the roller screw mechanism 10.

The fitting tool 70 comprises an annular body 72 comprising a cylindrical through piercing 72a having an inner diameter greater than the outer diameter of the nut 18 and a plurality of cylindrical through voids 74i distributed evenly in the circumferential direction, i being the number of cylindrical through voids 74 corresponding to the number of rollers 22, between 1 and n. The fitting tool 70 comprises, level with each cylindrical void 74, an angular visual positioning feature 76i for each of the rollers 22.

The rollers 22 are fitted in the gear wheel 34 as follows:

A reference point P is determined on the gear wheel 34. Once the reference point P has been determined, a first roller 22i is positioned manually in the associated void 45i of the annular spacer ring referenced 44 so that the angular visual positioning feature 60 of the first roller 22i is facing the predetermined reference point P, i being the number of rollers 22 and of voids 45, between 1 and n.

The first roller 22i is then manually made to turn on itself in such a way that it is displaced radially in the gear wheel 34 until the adjacent void 45i+1 formed in the annular spacer ring 44 is level with the previously predetermined reference point P.

Once the first roller 22i is fitted in the gear wheel 34, the fitting tool 70 is positioned around the nut 18 in such a way that the angular visual positioning feature 76i of the fitting tool 70 is in the same angular position as the angular visual positioning feature 60 of the first roller 22i and all the other rollers 22n are positioned in the angular positions corresponding to the angular positions of the angular visual positioning feature 76i of the fitting tool 70.

By virtue of the invention, it is possible to easily fit the rollers in the nut by virtue of the angular visual positioning feature formed on each of the rollers.

A fitting method is thus obtained that allows for an easy indexing of the rollers in the nut.

1. A roller screw mechanism comprising:
a screw having an outer threading;
a nut arranged around and coaxially to the screw, the nut having an inner threading; and
a plurality of mutually identical rollers interposed between the screw and the nut,
each mutually identical rollers having an outer threading engaged with the outer and inner threadings of the screw and of the nut, the threading of each roller being prolonged axially at each end by teeth which are themselves prolonged axially by a cylindrical journal extending outwards,
two annular gear wheels fixed in an unthreaded part of the bore of the nut and each internally comprising teeth respectively engaged with the teeth of the rollers and two annular spacer rings each fitted radially between the screw and the associated gear wheel and comprising a plurality of cylindrical through voids distributed evenly in the circumferential direction and inside which the journals of the rollers are housed,
wherein each of the rollers comprises an angular visual positioning feature making it possible to place the rollers in one of the annular gear wheels with respect to a predetermined reference point of the gear wheel or of the nut.

2. The roller screw mechanism according to claim 1, wherein the angular visual positioning feature is produced outside the threading.

3. The roller screw mechanism according to claim 2, wherein the angular visual positioning feature is produced on one of the lateral radial surface or the cylindrical axial surface of one of the sets of teeth.

4. The roller screw mechanism according to claim 2, wherein the angular visual positioning feature is produced on one of the lateral radial surface or the cylindrical axial surface of one of the journals.

5. The roller screw mechanism according to claim 1, wherein the angular visual positioning feature is a deformation, a machining or a marking.

6. The roller screw mechanism according to claim 1, wherein the angular visual positioning feature is produced before the threading of the roller.

7. A fitting tool adapted for fitting rollers in a roller screw mechanism,
the roller screw mechanism comprising:
a screw having an outer threading;
a nut arranged around and coaxially to the screw, the nut having an inner threading; and
a plurality of mutually identical rollers interposed between the screw and the nut,
each mutually identical rollers having an outer threading engaged with the outer and inner threadings of the screw and of the nut, the threading of each roller being prolonged axially at each end by teeth which are themselves prolonged axially by a cylindrical journal extending outwards,
two annular gear wheels fixed in an unthreaded part of the bore of the nut and each internally comprising teeth respectively engaged with the teeth of the rollers and two annular spacer rings each fitted radially between the screw and the associated gear wheel and comprising a plurality of cylindrical through voids distributed evenly in the circumferential direction and inside which the journals of the rollers are housed,
wherein each of the rollers comprises an angular visual positioning feature making it possible to place the rollers in one of the annular gear wheels with respect to a predetermined reference point of the gear wheel or of the nut; and
the fitting tool comprising:
an annular body having a cylindrical through piercing having an inner diameter greater than the outer diameter of the nut and a plurality of cylindrical through voids distributed evenly in the circumferential direction and each having an angular visual positioning feature for each of the rollers.

8. A method for fitting rollers in a roller screw mechanism, the roller screw mechanism comprising:
a screw having an outer threading;
a nut arranged around and coaxially to the screw, the nut having an inner threading; and
a plurality of mutually identical rollers interposed between the screw and the nut,
each mutually identical rollers having an outer threading engaged with the outer and inner threadings of the screw and of the nut, the threading of each roller being prolonged axially at each end by teeth which are themselves prolonged axially by a cylindrical journal extending outwards,
two annular gear wheels fixed in an unthreaded part of the bore of the nut and each internally comprising teeth respectively engaged with the teeth of the rollers and two annular spacer rings each fitted radially between the screw and the associated gear wheel and comprising a plurality of cylindrical through voids distributed evenly in the circumferential direction and inside which the journals of the rollers are housed,
wherein each of the rollers comprises an angular visual positioning feature making it possible to place the rollers in one of the annular gear wheels with respect to a predetermined reference point of the gear wheel or of the nut;
the method comprising steps of:
determining a reference point on one of the gear wheels or on the nut;
positioning a first roller in the associated void of one of the annular spacer rings so that the angular visual positioning feature of the first roller is facing the predetermined reference point; and
turning the first roller on itself until the adjacent void formed in the annular spacer ring is level with the predetermined reference point.

9. The method for fitting rollers in a roller screw mechanism according to claim 8, further comprising steps of:
positioning a second roller in the associated void of the annular spacer ring so that the angular visual positioning feature of the second roller is facing the predetermined reference point; and
turning the second roller on itself until the adjacent void formed in the annular spacer ring is level with the predetermined reference point and
repeating the step of placement and rotation for each of the rollers.

10. The method for fitting rollers in a roller screw mechanism according to claim 8, wherein, after having fitted the first roller in the gear wheel, the fitting tool is positioned around the nut in such a way that an angular visual positioning feature of the fitting tool is in the same angular position as the angular visual positioning feature of the first roller and all the other rollers are positioned in the angular positions corresponding to the angular positions of the angular visual positioning feature of the fitting tool.
